(19) United States
(12) Patent Application Publication
(10) Pub. No.: US 2006/0120211 A1
(43) Pub. Date: Jun. 8, 2006

(54) Method of manufacture and bottling for encoded microclustered liquids

(76) Inventor: Mark S. McCoy, Foster City, CA (US)

Correspondence Address: Jonathan D. Hanish;Sierra Patent Group, Ltd., P.O. Box 6149, Stateline, NV, 89449, US

(21) Appl. No.: 11/272,466

(22) Filed: Nov. 10, 2005

Related U.S. Application Data
(60) Provisional application No. 60/627,749, filed on Nov. 12, 2004.

(51) Int. Cl. B01F 11/00

(52) U.S. Cl. 366/108

(57) ABSTRACT

A method for manufacturing encoded microclustered liquids comprising: providing a starting liquid; shielding said liquid from unintentional vibrational and electromagnetic sources; mechanically vortexing said liquid until desired surface tension and zeta-potential are achieved; encoding said liquid with desired vibrational and electromagnetic sources; and bottling said liquid.

### CROSS-REFERENCE TO RELATED APPLICATIONS

This application claims priority to U.S. Provisional Application Ser. No. 60/627,749, filed Nov. 12, 2004, which is hereby incorporated by reference as if set forth herein.

### BACKGROUND OF THE IINVENTION

1. Field of the Invention

The invention relates generally to microclustered liquids. More specifically, the invention relates to the intentional imparting of vibrational and electromagnetic resonances into microclustered liquids and the intentional shielding of liquids from extraneous vibrational or electromagnetic resonances. Additionally, the invention relates to the synthesis and treatment of encoded microclustered liquids to produce a broad range of engineered and structured liquids having useful properties in a variety of applications.

2. The Prior Art

Nature has always structured, encoded, and repeated the cycle for all water by maintaining its perpetual hygroscopic cycle and by perpetual motion, such as cascading down glaciers and mountains, flowing in rivers and streams, or sinking and surging deep underground in aquifers. Intense sound, light, and vortical or kinetically generated vibrational or electromagnetic energy fields energize the water and structure it into smaller and smaller molecular clusters. These smaller molecular clusters resonate at higher frequencies that are maintained until water is made dormant through either natural or unnatural causes.

Throughout, water picks up a perpetually growing “memory” of the frequency imprints of all matter it comes into contact or proximity with until it is evaporated and condensed to start its cycle over again as an impressionable blank slate. Unfortunately in our present environmental condition, chemical and electromagnetic pollution and negative, low vibrational frequencies abound to sabotage water's natural processes and dramatically limit the access to natural source, micro-clustered, high vibrational resonance water.

The chemical formula of water has long been considered H₂O. Lorenzen (U.S. Pat. No. 5,711,950), hereby incorporated by reference as if set forth herein, teaches that water is composed of H₂O molecules that bond to one another to form clusters that have been characterized as coming in five distinct structural variations: unbonded, tetrahedral hydrogen bonded molecules comprised of five H₂O molecules in a quasi-tetrahedral arrangement, and surface connected molecules connected to the clusters by 1, 2, or 3 hydrogen bonds. Lorenzen further teaches that the presence of dissolved solutes causes the structure and properties of liquid water to change, referencing Lehninger, A. L. Biochemistry p. 44 (1975).

Holloway, et al. (U.S. Pat. No. 6,521,248), hereby incorporated by reference as if set forth herein, teaches that these micro-clusters of water can then form larger arrays of varying crystalline geometric and non-geometric structures, consisting of varying amounts of these micro-cluster molecules with weak, long distance Van der Walls attraction forces holding the arrays together and defining their structure by one or more of such forces as: (1) dipole-dipole interaction, i.e., electrostatic attraction between two molecules with permanent dipole moments; (2) dipole-induced dipole interactions, in which the dipole of one molecule polarizes a neighboring molecule; and (3) dispersion forces arising because of small instantaneous dipoles in atoms.

Under normal conditions the tetrahedral micro-clusters are unstable and reform into larger arrays from agitation, which impart London Forces to overcome the Van der Waals repulsion forces. Dispersive forces arise from the relative position and motion of two water molecules when these molecules approach one another, and results in a distortion of their individual envelopes of intra-atomic molecular orbital configurations. Each molecule resists this distortion, resulting in an increased force opposing the continued distortion, until a point of proximity is reached where London Inductive Forces come into effect. If the velocities of these molecules are sufficiently high enough to allow them to approach one another at a distance equal to Van der Waals radii, the water molecules combine.

There are currently multiple recognized processes by which large molecular arrays of liquids can be fractionated, including those claimed in Lorenzen and Holloway.

Use of smaller molecular structures (e.g. micro-clusters) of water for general consumption, medicinal, agricultural, and chemical processes has proved advantageous for many reasons including: (1) accelerated intra-cellular transport of nutrients in and waste out, for an overall enhanced and improved cellular communication (this is in part because protein channels in the cellular membrane called “aquaporins” only permit single file influx of water molecules in clusters 3-6 angstroms in diameter, while most purified or tap water sources are 20-30 angstroms in diameter); (2) accelerated intra-cellular transport of drug agents in and drug metabolites out (again, this is also in part because protein channels in the cellular membrane called “aquaporins” only permit single file influx of water molecules in clusters 3-6 angstroms in diameter, while most purified or tap water sources are 20-30 angstroms in diameter); (3) Enhanced blood/sap circulation as smaller water molecules will give an equal volume of water a higher Zeta-Potential, increasing antioxidant activities, and, if consumed by animal or plant life, the increased negative charge of the blood or sap plasma will increase and maintain cellular discreetness; (4) Faster growth of plants facilitated by the aforementioned increase in efficiency of intra-cellular communication; (5) Faster chemical extraction and dissolution processes due to increases in surface area of smaller water molecules.

While the above natural and scientific descriptions of water facilitate an understanding of water's unique physical bonding and clustering qualities, and of some of the advantages of using microclustered structured water, it is not the most helpful in understanding water's vibrational and electromagnetic frequency memory and resonance imparting qualities that can further affect the qualities of the microclustered water.

It is now understood that water has a near infinite ability to “record” the vibrational frequency of all matter it comes into contact with or in proximity of, especially while in perpetual motion, as in its natural excited state. As such, it can carry this “memory” into whatever life form ingests it, affecting the life form “homeopathically” (to be discusses subsequently) via communication with the water already within the life form, such as blood plasma or plant sap. Scientific demonstration and explanation of this quantum characteristic of water was first accomplished by Dr. Linus Pauling who demonstrated that it was at the covalent bonds, the same bonds that affect the water cluster qualities, that water retains memory of the frequency “imprints” of all matter it has come into contact with since its condensation from vapor in the hygroscopic cycle or its distillation with no “memory” from its past cycle.

Further supplementing Dr. Pauling's work is the research of scientists such as Dr. Jacques Benviste of France, Dr. Wolfgang Ludwig of Temple University in Philadelphia, Dr. Enzo Ciccolo of the Cooperative Nuova in Milan, Italy, Dr. Horst Felsch, the Director of the Civil Environmental Laboratory in Fieberbrunn, Germany, and Drs. Engler and Kokoschinegg. They have performed various cooperative and peer reviewed experiments with water and have arrived at these scientifically supported conclusions:
(1) Every atom, molecule, or substance has its own unique oscillation pattern or vibration that can be measured in electromagnetic wavelengths.
(2) Water is a carrier of information; as a solvent it is the best-known conductor of vibration, with information transfer possible without direct contact.
(3) Water possesses the ability to store information that has been impressed upon it from a given vibration for long periods, as can be measured by specific electromagnetic wavelengths found in it; thus, even after harmful physical or chemical substances are removed, their oscillatory vibrational patterns, or “imprints” still remain, which can be traced back precisely to the original substances.
(4) Water can transfer such information from vibrational patterns, or “memory”, to other systems, including living organisms.
(5) Water revitalization allows water in a higher vibrational state to transfer, or share, its higher frequencies, which act to balance out low energy and life detracting information.
(6) Water can retain the vibrational memory of a substance even after it is diluted beyond Avogardro's number, where no physical traces of the substance remain.
(7) Water quality can also be evaluated by the amount of ultra-violet light it absorbs. “Poor” quality water will absorb higher amounts of UV light, while “good” quality water absorbs low amounts.
(8) The minimum specific warmth and the maximum structural potential of water is measured at 37.5 degrees C., or the normal human body temperature (98 degrees F.) which indicates that water at this temperature is at a maximal structure point to acquire or share a large amount of information. It is at normal body temperature that water has the ability to acquire or share the most negative or positive information.

Therefore, current scientific research indicates that water must be considered in terms of a trio of qualities: size of molecular clusters, structure of molecular clusters, and the vibrational and electromagnetic frequency imprints or “memory” at the covalent bonds. All three qualities co-exist to define the Holistic value of the water relative to all living and non-living matter. The third quality of vibrational and electromagnetic frequency imprints or memory has been neglected in the prior art and in the field in general.

The inventor has discovered that, like a vibrating tuning fork initiating a chord, high vibration or electromagnetic frequency encoded water can be used to raise the vibrational or electromagnetic frequency of lower frequency vibration or electromagnetic frequency encoded water, thereby “re-vitalizing” lower frequency imprinted water through either direct contact or proximity.

Currently, micoclustered liquids/waters are manufactured by one of the following ways:
(1) By boiling water to produce steam that is passed across a magnetic field, exposing the steam to light at specific wave lengths, condensing the steam, adding a stabilizing metasilicate salt, adding a nutritional or pharmaceutical agent to the condensed steam, exposing the condensed steam to a pressure greater than one atmosphere, and depressurizing the condensed steam. (Lorenzen, U.S. Pat. No. 5,711,950 and U.S. Pat. No. 6,033,678)
(2) By causing cavitation in a liquid to form cavitation bubbles under a first pressure followed by depressurization to a second pressure to cause implosion and explosion of the cavitation bubbles such that acoustical energy shockwaves are created in a great enough strength to re-structure the starting liquid into micro-clusters. (Holloway, U.S. Pat. No. 6,521,248)
(3) By pressurizing a liquid through a vortex inducing body and then depressurizing. (Holloway, U.S. Pat. No. 6,521,248)
(4) By mechanically Vortexing water to energize and increase Zeta-potential resulting in micro-clustered restructuring.
(5) By adding a highly energized micro-clustered concentrate with super-microscopic colloids to a low mineral content starting water, i.e. distilled water to restructure the starting water into micro-clustered water.
(6) By a combination of methods three or four, and five.

The disadvantages of currently patented microcluster liquids, manufacturing approaches and their related art include a complete oversight in terms of monitoring what vibrational or electromagnetic frequencies have been encoded into the starting water, the water in process, the manufactured microclustered water, the bottled microclustered water, and the distributed bottled microclustered water. While there are references involving usage of specific vibrational or electromagnetic frequency sources (i.e. pressure differentiations, shaking, centrifuging, photonic or laser and magnetic field applications, etc.) for affecting the structure of the water clusters in process, and/or the uptake of a physical additive, there are none involving the memory of these frequencies or any other vibrational or electromagnetic frequency source being encoded purposefully into the covalent bonds of the water.

There are no references in any prior art or any commercially adhered to manufacturing process known to the inventor wherein the intentional and unintentional vibrational or electromagnetic frequencies being encoded into the water during the manufacturing process, distribution, merchandising, and usage of the water is addressed actively and preventatively as in the present invention.

Finally, none of the prior art offers any means by which the end user can “re-energize” the liquid as in the present invention, which offers this by means of the usage of a novel bottle design that enables the manual agitation induced vortexing of the liquid before use and/or in the process of pouring.

### BRIEF DESCRIPTION OF THE INVENTION

It is one of the objects of the present invention to provide an encoded micro-clustered water with sufficiently high enough vibrational or electromagnetic frequency to functionally “revitalize” or raise the vibrational or electromagnetic frequency of other water or water-based matrixes it comes into contact or proximity with.

It is also an object of the present invention to provide an encoded micro-clustered water with specific vibrational frequencies, ranges of vibrational frequencies, and sequences of specific vibrational or electromagnetic frequencies or sequences of vibrational or electromagnetic frequency ranges encoded to functionally affect the flow of subtle energies through animal and plant life.

It is yet another object of the present invention to provide a means of manufacture of encoded micro-clustered water.

The present invention is intended to be used for safe and beneficial purposes, such as encoding the frequencies of therapeutic Naturopathic preparations, Homeopathic preparations, beneficial sound and light frequencies, piezoelectronic crystals and other natural elements into micro-clustered water for experimental, performance enhancement, and therapeutic purposes.

However, it should not be lost on one skilled in the art that the present invention can be used to encode other vibrational or electromagnetic frequencies into micro-clustered liquids that could possibly be used for commercially viable purposes. Such vibrational and electromagnetic sources include poisons and harmful chemicals, bio-hazards, alloys, and ceramics. Examples of commercially viable purposes include reducing chemicals needed for pesticidal effectiveness, providing faster bio degradation by enabling chemical products to be effective in a more dilute form, and preparing metals, cements, and ceramics for blending, molding, or surface treatments. Such uses should also be considered to be within the scope of the present invention.

The present invention is distinguished from any related prior art by its focus on specific vibrational and electromagnetic frequency encoding characteristics.

It is therefore an object of the present invention to provide encoded microclustered liquids and method of manufacture, bottling, and distribution of completely novel design and/or representing clear and substantial improvements upon prior art and/or intended to work in conjunction with, and broaden the range of use for many forms of commonly used microclustered liquid methods and apparatuses.

It is another object of the present invention to provide encoded microclustered liquids and method of manufacture, bottling, and distribution with many advantages and benefits over traditional liquids and microclustered liquids and their respective manufacturing, bottling, and distribution methods, while maintaining the cost effectiveness, convenience, and desirability of operation to enable accessibility by the general public and that can be easily manufactured and marketed.

It is a further object of the present invention to consist of a plausible manufacturing technique and incorporate a manual agitation vortex inducing bottle design to enable durable and reliable construction out of a variety of materials, especially those preferred for FDA compliance and medical grade manufacturing.

An even further object of the present invention is to provide encoded microclustered liquids and method of manufacture, bottling, and distribution which are susceptible of low cost of manufacture with regard to both materials and labor, and which accordingly is then susceptible of low prices of sale to the consuming public, thereby making such encoded microclustered liquids economically available to the buying public.

### BRIEF DESCRIPTION OF THE DRAWING FIGURES

FIG. 1 is a flow chart for a preferred embodiment of the manufacture of encoded microclustered liquids;

FIG. 2 is a flow chart for an exemplary embodiment of the manufacture, bottling, and distribution of encoded microclustered liquids;

FIG. 3 is an orthographic cross-sectional view of a preferred embodiment of the vortical processing vessel; and

FIG. 4 is an orthographic cross-sectional view of a preferred embodiment of the manual agitation vortex inducing bottle.

### DETAILED DESCRIPTION OF THE INVENTION

The following description of preferred embodiments of the invention is not intended to limit the scope of the invention to these preferred embodiments, but rather to enable any person skilled in the art to make and use the invention.

The present invention provides a method of manufacture, bottling, and distribution of vibrational and electromagnetic encoded microclustered liquids from a liquid starting material.

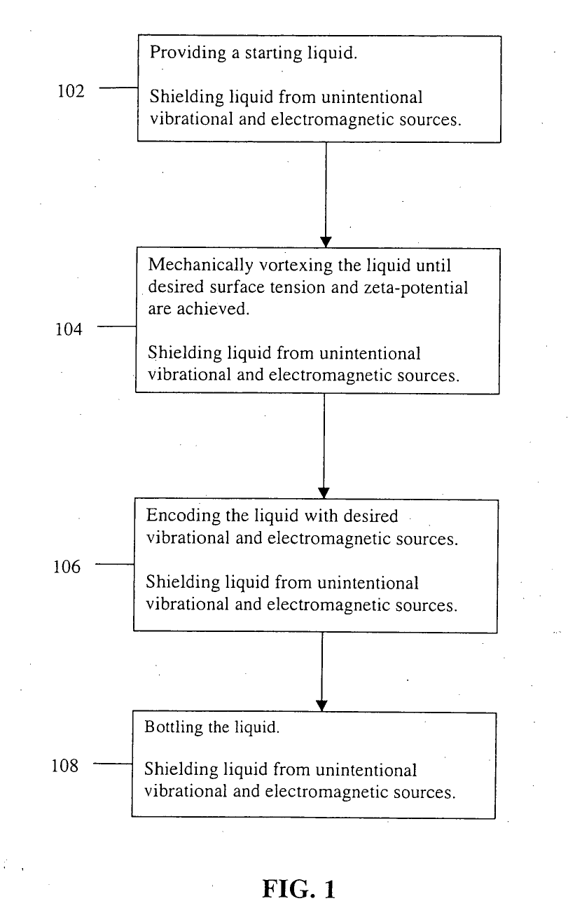

FIG. 1 presents the basic steps for manufacturing encoded microclustered liquids. First, at reference numeral 102, a starting liquid is provided. This liquid is then mechanically vortexed until a desired surface tension and zeta-potential are achieved, at reference numeral 104. Next, at reference numeral 106, the liquid is encoded with desired vibrational and electromagnetic sources. Finally, at reference numeral 108, the liquid is bottled.

As will be explained in more detail below, the liquid is shielded from unintentional vibrational and electromagnetic sources throughout the process. A shielding assessment may be performed prior to the vortexing at step 104. For example, before the liquid is vortexed at a manufacturing facility, the facility may be analyzed to determine the existence of any vibrational or electromagnetic sources that may affect the liquid. Based on this analysis, steps may be taken to either increase or decrease the affect these sources may have on the liquid, such as using additional shielding, rearranging equipment or simply removing these sources from the manufacturing facility.

Also, it should be noted that the liquid can be encoded with desired vibrational and electromagnetic sources at anytime in the process, and as often as appropriate. For instance, the liquid may be encoded even after being bottled. This may serve to supplement, or even replace the encoding that occurs before the liquid is bottled.

The liquid starting material is preferably a distilled water or other low mineral/particulate content water with less than 30 ppm total dissolved solids. It may optionally comprise the addition off any desired additives, such as flavors, naturapathic preparations, homeopathic preparations, herbs and botanicals, essential oils, vitamins, minerals, pharmaceutical or other chemical agents.

The liquid starting material is put through the process of mechanical and/or manual agitation vortexing. In addition to mechanical and manual vortexing, it is contemplated any type of vortexing known in the art may be employed.

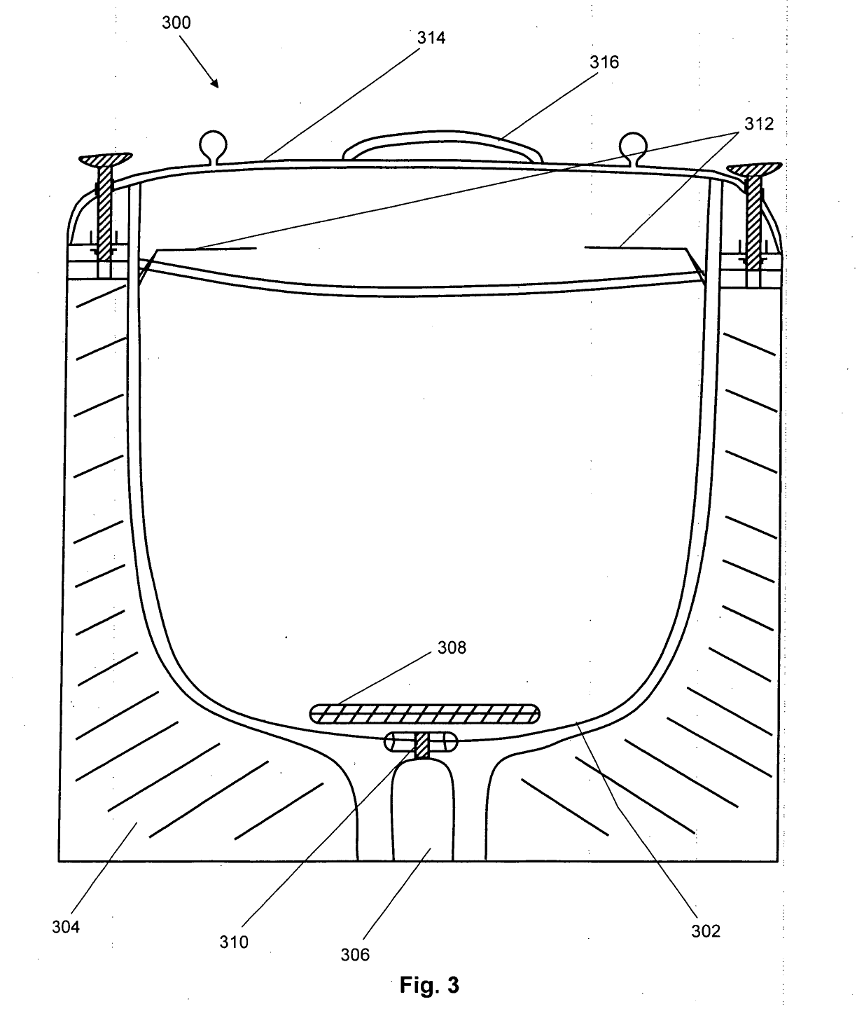

In a preferred embodiment, the liquid is pumped into a vortical agitation processing vessel, as shown in FIG. 3. The processing vessel 300 may comprise a reinforced stainless steel process vessel 302 that is encompassed by reinforced concrete 304. The processing vessel 300 also comprises a motor 306 at its base. The motor is coupled to a stir bar 308 through a drive shaft 310. When operated, the motor 306 causes the stir bar 308 to rotate. This motion of the stir bar 308 causes a vortex in the liquid, affecting its molecular structure, and in turn affecting its surface tension and zeta-potential.

Internal encoding source shelves 312 located inside the vessel 300 allow for the placement of desired vibrational and electromagnetic encoding sources in close proximity to the liquid going through the vortexing process. The top of the vessel may be covered by a vessel lid 314. While the vessel 302 is covered, the viewing window and pressure vent 316 located on the lid 314 serve to provide both a section where the user can view the vortexing process and a means of escape for excess pressure. Optionally, the viewing window and pressure vent 316 may be placed in other locations on the vessel 300 besides the lid 314. The viewing window and pressure vent 316 also may be placed in different locations with respect to one another.

The vortexing is maintained until the desired surface tension of 69 dynes or less and desired zeta potential is achieved. It preferably takes place within a spatial proximity of 170.1975 feet or less of a desired vibrational or electromagnetic frequency source. The desired frequency source can include a range of frequencies, a sequence of frequencies, or a sequence of ranges of frequency encoding sources, such as naturapathic preparations, homeopathic preparations, herbs and botanicals, essential oils, vitamins, minerals, crystals, and elements or elemental compounds.

This process may include the primary or secondary addition of any desired additives such as flavors, naturapathic preparations, homeopathic preparations, herbs and botanicals, essential oils, vitamins, minerals, pharmaceuticals or other chemical agents.

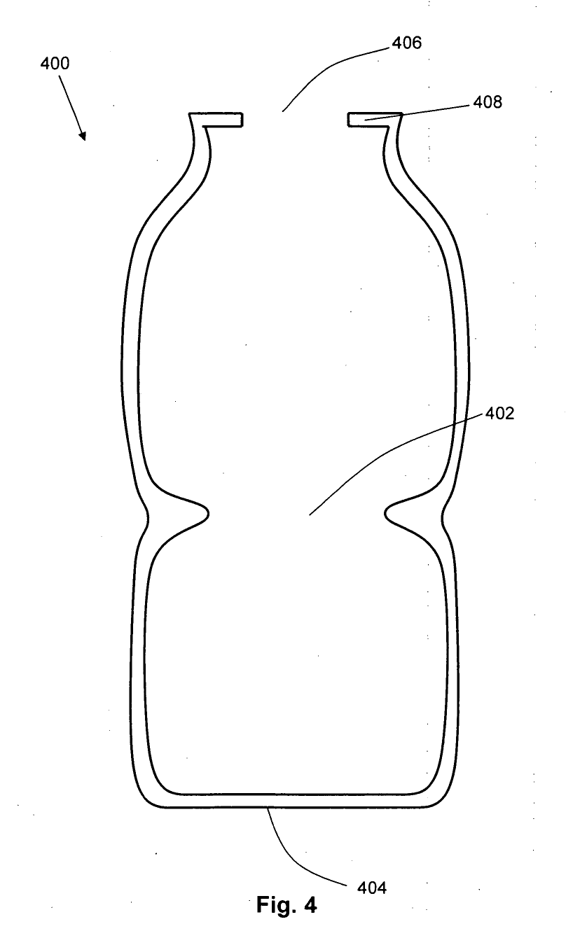

The encoded microclustered liquid is then bottled in a manual agitation vortex inducing bottle, such as the one shown in FIG. 4. In a preferred embodiment, the bottle 400 has an internal diameter reduction 402 located ½ to ⅓ of the way up from the base 404. The internal diameter reduction 402 has a diameter that is equal to ⅓ to ½ the size of the portion of the bottle with the largest inner diameter. This novel design allows for the efficient vortexing of the bottled liquid by the end user through manual agitation of the bottle 400. In a preferred embodiment, the user manually rotates the bottle 400 twice in one direction, and then once in the opposite direction. For example, the user may rotate the bottle 400 twice to the right and once to the left before use.

The bottle 400 also may include a pour spout reduction 406 with a diameter that is equal to ⅓ to ½ the diameter of the actual spout 408. Once again, this design allows for the efficient vortexing of the bottled liquid by the end user. Here, all the user has to do is pour the liquid out of the spout 408. The pour spout reduction 406 causes the liquid to be vortexed as it exits the spout 408.

The bottle may also contain specific vibrational or electromagnetic frequency encoding sources. These encoding sources may be part of the bottle itself or may be included in the bottle labeling materials.

As mentioned above, throughout the process, the liquid is shielded from unintentional vibrational and electromagnetic frequencies. From the starting liquid, through the vortexing process, to the end user, the liquid may be shielded from environmental thermal extremes outside the range of 33° F. to 69° F. and undesirable vibrational or electromagnetic frequencies, such as those emitted from electric or combustion engines, fragmental light spectrums, acoustical extremes, computers, phones, radio, and sonar.

Shielding may be accomplished in a variety of ways. For instance, the manufacturing of the encoded microclustered liquid can take place in an electromagnetic field controlled facility. Practical types of shielding techniques may include architectural shielding measures, such as Flectron or Numetal shielding materials in the walls and doors of the facility. The use of an external magnetic shield, in which a strong peripheral magnetic field diverts weaker fields from the manufacturing, bottling, and storage area is also within the scope of the invention.

Electromagnetic field protective cases and/or bottle shielding sleeves may be used in the storage and/or distribution of the liquid. Such cases and sleeves may consist of electromagnetic shielding materials such as Flectron, Numetal, or other shielding alloys or ceramics.

Shielding can also occur before or after the vortexing by freezing the liquid. The liquid may be intentionally frozen by the user. For instance, it may be placed in a freezer. The liquid may also be naturally frozen, such as with an ice burg.

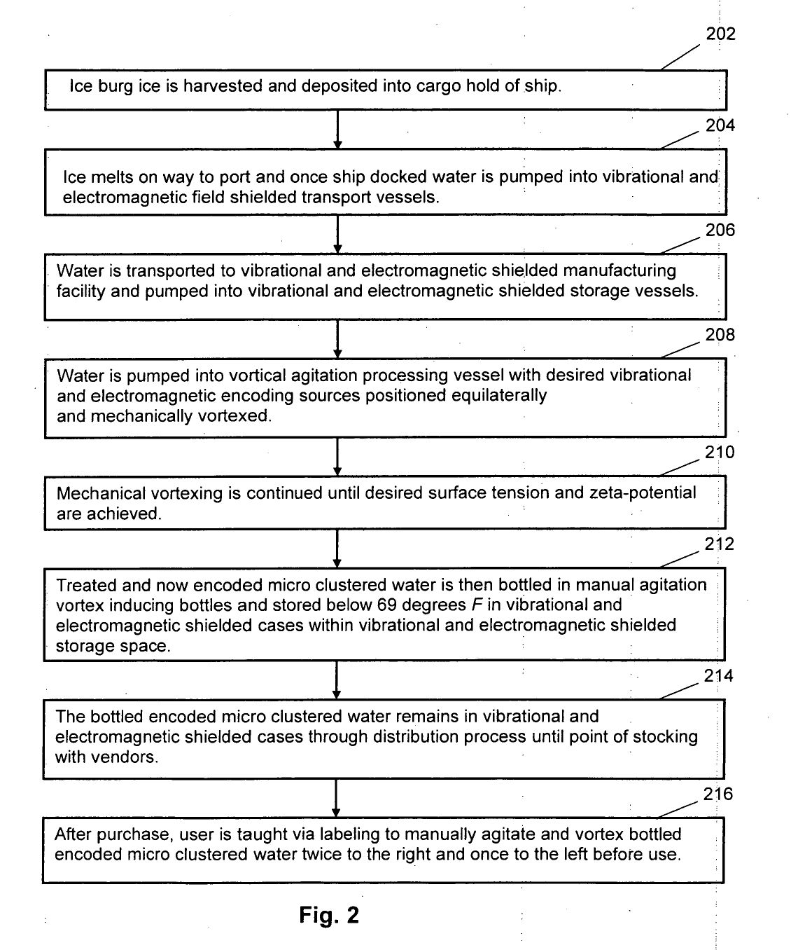

FIG. 2 presents an exemplary embodiment of the manufacture, bottling, and distribution of encoded microclustered liquids. This example is intended to illustrate a practical application of the present invention, not to limit its scope. Here, at reference numeral 202, an ice burg is harvested and deposited into the cargo hold of a ship.

At reference numeral 204, as the ship makes its way to port, the ice melts, resulting in water. Once the ship is docked, the water is pumped into vibrational and electromagnetic field shielded transport vessels.

At reference numeral 206, the water is transported to a shielded manufacturing facility, where it is pumped into shielded storage vessels.

At reference numeral 208, the water is pumped into a vortical agitation processing vessel. The processing vessel has desired vibrational and electromagnetic encoding sources positioned equilaterally around the circumference of the processing vessel.

At reference numeral 210, the water is then mechanically vortexed. The vortexing continues until the desired surface tension and zeta-potential are achieved.

At reference numeral 212, the treated and encoded microclustered water is then bottled in manual agitation vortex inducing bottles. These bottles are stored at a temperature below about 69 degrees Fahrenheit in shielded cases within a shielded storage space.

At reference numeral 214, the bottled encoded micro clustered water remains in shielded cases throughout the distribution process until the bottles are stocked by vendors.

At reference numeral 216, after a user purchases a bottle, he or she may manually agitate and vortex the encoded microclustered water. The user is taught how to do this by the labeling on the bottle. In this example, the user vortexes the water by manually agitating the bottle twice in a first direction and once in a second direction that is opposite the first direction. For instance, the bottle may be rotated twice to the right and once to the left before use.

In another example (not shown), a liquid starting material may consist of low mineral content water sourced from a pristine spring. The water is stored in an approximately 5000 gallon stainless steel storage vessel, where it is filtered via Reverse Osmosis to about 3 ppm total dissolved solids and is pumped into a second 1800 gallon stainless steel vortical agitation processing vessel until the vessel is full.

The mechanical vortexing of the liquid starting material begins with a set of encoding sources positioned equilaterally around the circumference of the processing vessel at a distance of about three inches from the side of the tank. Also included are another set of encoding sources positioned equilaterally around the circumference of the processing vessel at a distance of about three inches from the side of the tank, alternating equilaterally and centered between the first set of encoding sources. The vortexing continues until the desired surface tension of about 63 dynes or less and desired zeta potential of about −333 mV or less is achieved. Then, the treated water is bottled in a manual agitation vortex inducing bottle, as previously described.

Attaining a micro-clustered structure by breaking the bonds via the implosion and explosion of tiny bubbles of entrained gases by way of cavitation, as Holloway teaches to create a plasma which dissociates the local atoms and reforms the atoms at a different bond angle and strength, can be achieved in a variety of ways. However, in order for a micro clustered liquid, such as water, to be of reasonable cost to manufacture, it must be manufactured utilizing a means by which it can be most efficiently subjected to cavitation sufficient to create the plasma effect and get the desired values for qualities such as surface tension, thermal density, and zeta potential. Additionally, in order for it to be a truly beneficial product, it must be able to make it to market and into the consumer's hands as maintaining or easily recalling these desirable qualities. Many effective means of manufacture are not efficient, and therefore, not conducive to competitive cost of manufacture. Holloway's commercially used approach, which is most likely Holloway's most efficient approach from their real world experience using their technology, actually takes eleven hours to process the water.

Therefore, in addition to the EMF purity and the contamination, shielding, and encoding considerations, the present invention's improvements over the prior art include a substantially more efficient means by which to process the water to achieve the micro clustered structure by way of a high velocity vortex/counter-vortex process. The vortex/counter-vortex process can be induced by pressurizing the water sequentially and in a reverse direction through sealed and empty mirror opposite centrifugal pump volutes. For example, this process may comprise pressurization, followed by rapid depressurization inducing a right spinning high velocity vortex, followed by a second pressurization, rapid depressurization inducing a left spinning high velocity vortex, followed by a helical return to the tank and recirculation through the system, and the inclusion of negative charge carrying nano-colloidal silica particles. The process may also include measures to maintain the integrity of the structure, including the use of nano-collodial particles (dual purpose: faster microclustering and enhanced stability and recall), pressurization, and the manual vortex (cavitation) inducing bottle.

The present invention may therefore include nano-colloidal particles being added to the liquid, vortex/counter-vortex processing in an EMF shielded space with only desirable encoding sources present and/or present in the packaging. The packaging may also include the shielding measures and the manual vortex capability.

Holloway discloses that the acoustical energy created by the cavitation breaks the static electric bonds holding a single tetrahedral micro-clusters of five H.sub.2 O molecules together in larger arrays, thereby decreasing their size and/or creating a localized plasma in the water restructuring the normal bond angles in a different structure of water.

The inventor of the present invention has found significant advantages to adding a small amount (i.e. about 1.25 ml/gallon) of highly homogenous, high pH, nano-colloidal silica particle sol to an ultra pure starting water, pressurizing the water out of a tank by pump, forcing the water backwards through sequential mirror opposite centrifugal pump volutes inducing a high velocity vortex, followed immediately by a high velocity counter vortex and helically routed back into the tank without any sharp angles in a continuous cycle. As a result, the length of time and amount of energy required to achieve the desired microclustered liquid qualities can be drastically reduced from other methods, the same method without the use of the nano-silica sol, and the same method using sharp angles in the return plumbing.

The inventor of the present invention has also found that the inclusion of the nano-colloidal silica particles, which enables the maintenance of a very low TDS yet high charge carrying surface area, results in greater stability and longevity of the micro-clustered state of the liquid and less required energy to improve the desirable surface tension and zeta potential qualities with post production cavitations. This is because the released negative charges from the breaking of H-bonds affects the water structure longer as an increase to the charge carried on the particle surfaces or supplemented with the negative charge pre-existing on the particle surfaces, than it does as a restructuring “water plasma” state, as is the case if pure water without charge carrying nano-particles is processed. Additionally, the more homogenous the particle size, the more homogenous the particle charges and resulting colloidal system wide repulsion enhancing longevity of the micro-clustered liquid state post production.

The homogenous nano-colloidal particle sol may be made using the following process. Electro-Chemical reactions are used to disperse the various particle sizes of the dry silica particles which are added to ultra pure water to create the sols. Colloidal silica sols are stabilized against aggregation into larger particle sizes by causing the silica particles to become negatively charged so that they repel each other. This is achieved by the addition of small amounts of alkali (hydroxyl ions), which react with the silica surface to produce the negative charge.

Hydroxyl ions have two important effects. First, they react with surface silanol groups to create negative surface charges, which cause the particles to repel each other. This inhibits aggregation or gel formation. Second, they directly catalyze the formation of siloxane cross-linkages or gel formation. Therefore, at high pH, colloidal silica particles are stable because of high particle charge.

As pH drops, particle charge decreases, but sufficient hydroxyl ions remain to catalyze cross-linking, and stability can be maintained as long as there is great enough dilution.

Surfactants can be added to formulations containing colloidal silica to improve wetting properties. The nano-colloidal sol may contain trace amounts of potassium oleic acid for this purpose. Other ions may be present, such as Ca, K, and Mg. Generally, nano-colloidal silica sol is used with particles in the sub 10 nm range that is stabilized by high pH prior to use, giving the particles their pre-existing negative charge, and then by high dilution.

As mentioned above, in addition to mechanical and manual vortexing, any type of vortexing known in the art may be used as well.

As would be appreciated by one skilled in the art, modifications and changes can be made to the preferred embodiments of the invention without departing from the scope of the invention defined in the following claims.

Such modifications may include variations of the micro-cluster liquid manufacturing techniques including or followed by the same encoding processes. Other variations are likely to include various manufacturing environment controls, bottle designs, and electromagnetic field protective measures incorporated during distribution.

What is claimed is:

1. A method for manufacturing encoded microclustered liquids comprising:
providing a starting liquid;
shielding said liquid from unintentional vibrational and electromagnetic sources;
mechanically vortexing said liquid until desired surface tension and zeta-potential are achieved;
encoding said liquid with desired vibrational and electromagnetic sources; and
bottling said liquid.

2. The method of claim 1 wherein said starting liquid is distilled water.

3. The method of claim 1 wherein said starting liquid is low mineral/particulate content water with less than 30 ppm total dissolved solids.

4. The method of claim 1 wherein said starting water is low mineral/particulate content water with less than 30 ppm total distilled solids.

5. The method of claim 1, further comprising adding desired additives to said liquid.

6. The method of claim 1 wherein said liquid is shielded from unintentional vibrational and electromagnetic sources by an electromagnetic field controlled manufacturing facility.

7. The method of claim 1 wherein said liquid is shielded from unintentional vibrational and electromagnetic sources by a shielding material.

8. The method of claim 7 wherein said shielding material is Flectron.

9. The method of claim 7 wherein said shielding material is Numetal.

10. The method of claim 1 wherein said desired surface tension is 69 dynes or less.

11. The method of claim 1 wherein said desired zeta-potential is −333 mV or less.

12. The method of claim 1 wherein said encoding said liquid comprises placing said liquid within a spatial proximity of said desired vibrational or electromagnetic sources.

13. The method of claim 12 wherein said spatial proximity is 170.1975 feet or less.

14. A manual agitation vortex inducing bottle having a base and a spout, comprising:
an internal diameter reduction, said internal diameter reduction is configured to vortex liquid.

15. The vortex inducing bottle of claim 14 wherein said internal diameter reduction is configured to vortex said liquid by said bottle being manually agitated.

16. The vortex inducing bottle of claim 15 wherein said bottle is manually agitated by being rotated twice in a first direction and once in a second direction opposite said first direction.

17. The vortex inducing bottle of claim 14 wherein said bottle also comprises specific frequency encoding sources.

18. The vortex inducing bottle of claim 17 wherein said encoding sources are part of the bottle itself.

19. The vortex inducing bottle of claim 17 wherein said encoding sources are included in the bottle labeling materials.

20. A manual agitation vortex inducing bottle having a base and a spout, comprising:
a pour spout reduction, said pour spout reduction is configured to vortex liquid.

21. The vortex inducing bottle of claim 20 wherein said pour spout reduction is configured to vortex said liquid by said bottle being manually agitated.

22. The vortex inducing bottle of claim 21 wherein said bottle is manually agitated by being rotated twice in a first direction and once in a second direction opposite said first direction.

23. The vortex inducing bottle of claim 20 wherein said bottle is configured to vortex liquid by said liquid passing through said pour spout reduction.

24. The vortex inducing bottle of claim 20 wherein said bottle also comprises specific frequency encoding sources.

25. The vortex inducing bottle of claim 20 wherein said encoding sources are part of the bottle itself.

26. The vortex inducing bottle of claim 18 wherein said encoding sources are included in the bottle labeling materials.
